(19) United States
(12) Patent Application Publication
(10) Pub. No.: US 2021/0311447 A1
(43) Pub. Date: Oct. 7, 2021

(54) DEVICE ROUTINES AND ROUTINE REPOSITORY

(71) Applicant: Google LLC, Mountain View, CA (US)

(72) Inventors: Michele Turner, Mountain View, CA (US); Kevin Po, Mountain View, CA (US); Gabriel Rubinsky, Mountain View, CA (US)

(21) Appl. No.: 17/223,988

(22) Filed: Apr. 6, 2021

Related U.S. Application Data
(60) Provisional application No. 63/005,772, filed on Apr. 6, 2020.

(51) Int. Cl. G05B 19/042; G06Q 30/06

(52) U.S. Cl. CPC G05B 19/042; G05B 2219/2642; G06Q 30/0641

(57) ABSTRACT

Techniques, devices, and systems are provided that allow for use of routines with one or more devices in a home management system, which provide more extensive functionality and greater integration between multiple devices than typically is provided by conventional scheduling functions. A routine repository is also provided in which routines from multiple distinct sources can be provided to devices that provide functionality incorporated into the routines without regard to source of the routine or device.

### CROSS-REFERENCE TO RELATED APPLICATIONS

This application claims priority to U.S. Provisional Application Ser. No. 63/005,772, filed Apr. 6, 2020, the disclosure of which is incorporated by reference in its entirety for all purposes.

### BACKGROUND

Home and office environments typically include multiple electronic devices that may operate alone or in conjunction with other devices in the environment. Joint or related operations may be controlled via a common controlling device such as a phone, home network base station, computer, or the like. Some devices include scheduling capabilities that allow common activities to be performed at a regular recurring time, such as a particular day of the week and/or time of day.

### SUMMARY

Embodiments disclosed herein provide devices, methods, and systems for implementing predefined routines in a home management system by detecting, by a home management system, that a first device is connected to a communication network of the home management system; obtaining model information about the device, the model information comprising at least a first feature of the first device available for use; obtaining a first predefined routine defining a plurality of functions and specifying one or more parameters under which one or more of the plurality of functions is used by the routine, at least a first function of the plurality of functions making use of the first feature of the first device; and presenting the first routine to a user of the home management system. Responsive to receiving approval of the first routine from the user, the home management system may implement the first predefined routine by the home management system to cause the first device to use the first feature based upon the parameters. The method of claim 1, wherein the first predefined routine is obtained from the first device, a routine repository storing a plurality of predefined routines, or from a provider of the first device.

The first predefined routine may be obtained from the routine repository storing a plurality of predefined routines. The plurality of predefined routines also may include routines suitable for use with devices from a plurality of independent and distinct sources. The first predefined routine may be obtained from the first device and may specify a second device that is capable of performing one or more other functions defined in the first predefined routine that are not performed by the first device. The home management system further may identify a second device already installed in the home that is capable of executing at least a second function of the plurality of functions; present an identification of the second device to the user; and/or, responsive to receiving approval of the first routine from the user, implement the first predefined routine by the home management system to cause the second device to execute the second function as defined in the first routine. Alternatively or in addition, the home management system may identify another device that is not already installed in the home that is capable of executing at least a second function of the plurality of functions; identify the other device to the user and providing an interface for the user to obtain the second device; and/or, responsive to an instruction received from the user, purchase the second device.

The parameters of the routine may specify environmental conditions under which the first function is performed, a behavior of the first device based on a presence or absence of another device connected to the communication network, a schedule of operation of the first device which specifies one or more times that the first function will be performed, one or more times that the first function will not be performed, or a combination thereof, or combinations thereof or the like.

The parameters may be based on information available from the home management system that is not otherwise available to the first device. The routine may be generated automatically by the home management system based at least in part upon a behavior of an occupant of the home previously determined by the home management system.

### BRIEF DESCRIPTION OF THE DRAWINGS

FIG. 1 shows an example system suitable for implementing and/or for use with embodiments disclosed herein.

FIG. 2 shows an example process according to embodiments disclosed herein.

FIG. 3 shows a schematic example of a routine repository as disclosed herein.

FIG. 4 shows a schematic representation of a computerized device suitable for use with embodiments disclosed herein.

### DETAILED DESCRIPTION

It is desirable for modern electronic devices, home/premises management systems, and the like to have capabilities that allow for automatic processes that take advantage of data available in the home environment, as well as the connected nature of the devices in that environment. For example, when a user purchases a new device that integrates with a computerized home management system, it may be desirable for the computerized home management system to automatically identify, or be informed of, functionality that may be available with the additional device installed. This functionality may vary from one location to another depending upon the specific devices and features already installed at the location. Alternatively or in addition, it may be useful for the home system and/or individual devices to suggest additional features or devices that may extend the functionality available to the system. Embodiments disclosed herein provide techniques, devices, and systems that allow for the use of device routines that enable such automation.

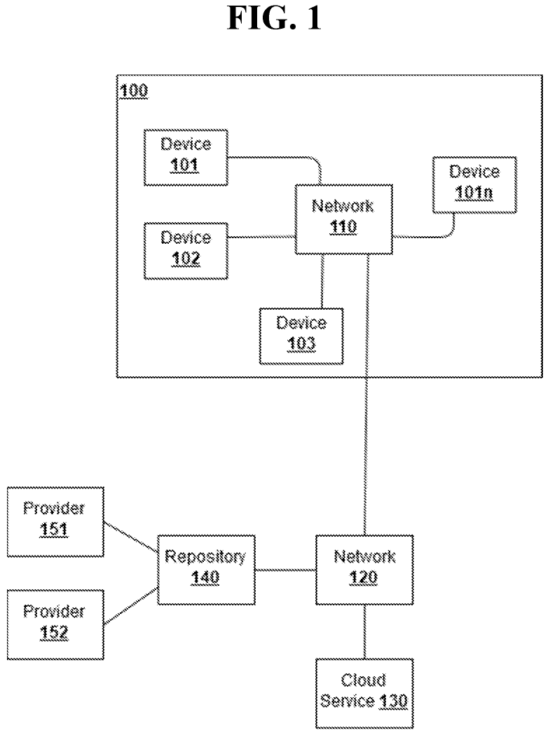

FIG. 1 shows an example system suitable for implementing and/or for use with embodiments disclosed herein. One or more devices 101, 102, 103, . . . 101n may be present in a home 100 or similar location, and may be connected to one another and other devices and networks through a home network 110 or similar. The home network 110 may be a physical and/or wireless network, and may include any standard network arrangement such as mesh networks, ad hoc arrangements, and the like. The network 110 may connect to a network 120 such as the Internet or other external network, which allows for communication between the devices 101 . . . 101n and other systems and services, such as cloud services 130 and routine repositories 140 as disclosed herein, as well as any other available systems, networks, services, and the like. As previously disclosed, in some embodiments the repository 140 may be provided by or otherwise associated with a cloud service 130 and/or it may be partially or entirely implemented on a local device such as a hub device. One or more device and/or service providers 151, 152 may communicate with the repository 140 to provide device routines, which then may be provided to the devices 101 . . . 101n as previously disclosed. One or more devices, such as device 101, may operate as a home management hub or similar device that functions to monitor and coordinate multiple devices within the home. As described in further detail below, such a device may determine when a new device 102, 103, 101n has been connected to a home network 110 and subsequently implement one or more routines that make use of the new device.

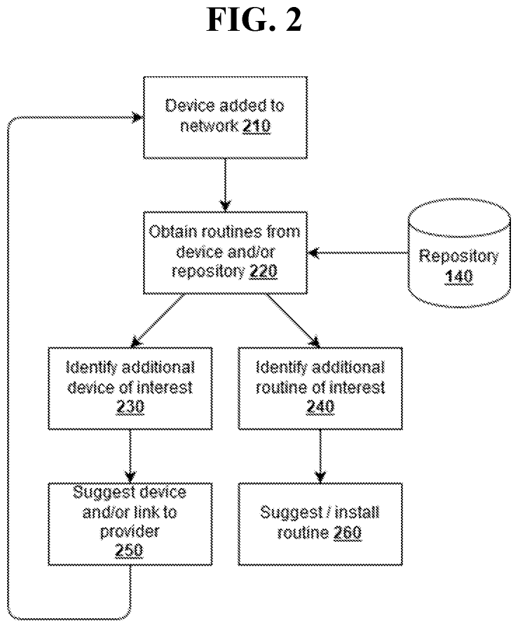

FIG. 2 shows an example process according to embodiments disclosed herein. It will be understood that the example process shown in FIG. 2 is provided by way of illustration only, and that many other processes may be used without departing from the scope of the subject matter disclosed herein. Specifically, processes disclosed herein may omit some steps shown in FIG. 2 and/or may include additional steps not shown in FIG. 2. Other devices may be used and the various steps shown may be provided by one or more devices or entities, as disclosed herein, without departing from the scope of the disclosed subject matter. The process described with respect to FIG. 2 may be performed by a home management system such as a security system, a “smart speaker” or similar device, a home networking hub, or the like, or it may be performed by one or more electronic devices operating which do not manage other aspects of the premises, such as a smart speaker, phone, and/or home management system that does not integrate with a security system, or the like. Some portions of the process may be performed by an electronic device in communication with such a system, or by multiple electronic devices operating alone or in concert. At 210, a new device may be added to a home environment, such as by connecting the device to a home network. At 220, one or more routines may be obtained from the device, a routine repository 140, and/or a device provider as previously disclosed, which describe behaviors of the device that may apply in the home. For example, a home management system or the like may obtain the routine(s) from the device, the repository, the device provider, or any other suitable source as disclosed herein. The routine(s) also may suggest one or more devices that may be of interest to a user at 230, and/or one or more routines that may be of interest to a user at 240. For example, the obtained routines may indicate additional efficiencies, functions, or other aspects of operation of the initial device, the home network, or other devices that may be available if another device and/or routine is used. The user may be guided to a purchase or install option for a new device at 250 as previously disclosed, after which the additional new device also may be added to the environment at 210. Routines as disclosed herein also may be used in conjunction with devices and services outside the immediate premises on which the triggering device is installed. For example, a routine may define actions that can be taken with respect to remote services or devices, such as alarms, communication with local authorities or alarm monitoring systems, music playback, order fulfillment, and the like. In some cases, a routine may make use of existing connective functionality when the remote device or system is not itself configured to make use of a routine as disclosed herein. For example, a home management system may include an API or similar interface to connect to a music playback system and/or a music subscription service. The routine may define functions to be used by such a system, such as playback of a song selected by a user or an automated system for identifying a “related” song. However, a particular song playback and/or subscription service may not themselves be configured to interact with a routine but may include an API or similar connection that allows the home management system to specify operation parameters of the systems, such as instructing playback of a song meeting specified parameters. In such a situation, the home management system or a routine management system connected thereto may use the existing connection to execute the associated functions defined in the routine.

As a specific example, an alarm system may provide an API that allows connected and authenticated devices to set the state of the alarm, such as home/armed/vacation/intrusion, etc. The home management system may be connected and authenticated via the API, such as to allow users of the home management system to set the state of the alarm via their phone even when not physically present in the home, but the alarm system itself may not be configured to interact directly with routines implemented by the home management system. If a routine specifies that an alarm should be set to “armed” in certain circumstances, the home management system may act as a bridge between the alarm system and the routine (and other devices that operate in accordance with the routine) to set the alarm to the “armed” state when those conditions are met. Thus, routines as disclosed herein still may trigger or otherwise interact with devices and services that are not within the home and/or which are not directly configured to use routines.

At 260, a user may be presented with one or more routines to be downloaded, enabled, installed, or otherwise implemented with respect to the device. In some embodiments, individual devices may receive one or more functions, commands, or the like for execution in association with a routine, which may be derived from the routine or explicitly defined in the routine. The routine as a whole may be executed and orchestrated by a central coordinating device such as a hub device or other home management device or system, and/or a cloud service.

As an example, a user may purchase a new device 101n such as an automated or autonomous cleaning device, which functions more effectively in certain lighting conditions. When the device is connected to the user's home network 110, the device 101n and/or a home management system 101 may identify this attribute of the cleaning device and also may determine that the lighting in parts of the home is conventional lighting that cannot be controlled by the management system or the device. A user interface of the home management system may notify a user that the cleaning device will function more efficiently or effectively if the conventional lighting is replaced by networked, controllable lighting devices, and may suggest specific devices, bulbs, control systems, or the like that may be especially suited to operate with the cleaning device. As a further example, the home management system also may be connected to a purchasing account of the user, thereby allowing the user to instantly purchase and approve shipment of the appropriate additional lighting devices. When the additional lighting devices are received, the home management system may automatically incorporate them into the scheduled routines of the cleaning device, thereby achieving the proposed increase in functionality.

As another example, the cleaning device or the home management system may determine that there are motion sensors in the home, for example as part of a home security service, that should be disabled while the device is moving around within the home. A pre-defined set of sensor behaviors may be provided by the cleaning device, the home management system or an associated platform, the sensors, or a combination thereof, which can be used to coordinate sensor activations and deactivations with the behavior of the cleaning device. The sensor and/or cleaning device behaviors may be described in one or more “routines”, which as used herein are defined sets or types of behavior for one or more connected devices. A routine may specify specific behavior, such as “turn off at 8:00 pm”, “notify a user when the battery charge is at 20%,” or the like. A routine may specify parameters for behavior, such as “do not enter a room unless the lights are turned on,” “turn on in sequence with other lights in the same group,” or the like. Routines may incorporate features of one device or multiple devices, and may specify behavior of those devices and/or additional devices in the home network. More generally, a routine may specify any behavior of a device based on any available device, device feature, environmental condition, user or device provider specification, or any other data. Concurrently-running routines may run in conflict with a cleaning routine (i.e., a security solution); for instance, motion sensors used to detect anomalies in a security system could accidentally trigger an alarm if a cleaning robot enters the room. Thus, the cleaning routine can signal to other potentially-conflicting routines to notify them of the issue to avoid negative user behavior.

In an embodiment of the present subject matter, a “routine repository” 140 may allow device providers, home management system providers, and other entities to provide routines for their own devices, for devices that operate in conjunction with their devices, and combinations thereof. For example, a home management system provider may provide a platform that coordinates presentation and delivery of stored routines to devices that are in communication with the home management system. Such a platform may be implemented as a cloud service 130, on a local device such as a home hub device 101 or similar controller, or a combination thereof. Continuing the prior example, the home management system 101 may provide a platform that stores routines for the sensors, the cleaning device, and connected lighting devices, such as devices 102, 103. When the cleaning device 101n is added to the home network, it may obtain one or more of the routines that specifies behavior of the cleaning device. The cleaning device also may provide information about its own capabilities, attributes, and pre-set routines. For example, the cleaning device may indicate a minimum lighting level at which it is designed to operate and provide a proposed cleaning routine based on known rooms in the home. The known rooms may be specified by a user or may be provided by the home management system.

In some embodiments, device and service providers may design routines that include optional functions depending upon the availability of other devices and functionality in a home system. As previously disclosed, the routine repository and/or individual devices also may notify users of additional functionality that may be available if other devices or functions are added to the home system.

In an embodiment, a home management system provider or other manager of a routine repository may provide a software development kit (SDK), application programming interface (API), or other components that allow device and service providers to access the routine repository, such as to add their own routines, access routines of other devices, or the like. Similarly, an SDK may be provided to allow for development of the routines themselves. For example, a home security service provider may design and provide routines for sensors in the home that can be used partially or entirely by sensors connected to the home network, regardless of whether the sensors are provided by the home security provider. Each sensor may use the components of such a routine that apply to it, while discarding or ignoring other components that do not apply, and/or each routine may specify which data from another device should be used or discarded by a device that implements the routine. For example, a routine may specify when an alarm should sound for an open window based on data obtained from a window sensor, while portions of the same or related routines that specify when a user should be notified of movement inside the home may not be used in conjunction with data from the same window sensor.

In an embodiment, routines also may use information that is available from a home network, home management system, or the like, which may not be available to individual devices or device providers otherwise. For example, a home management system may be configured to identify, or to receive from a user, information specifying when the user is at home, away for a short period of time, away for an extended period of time, or the like. Such conditions may be available for use in routines even where the underlying data (such as when a user has scheduled a future vacation, the specific parameters that define a home/away condition, or the like). For example, a routine may specify that lights should operate on a particular schedule if the home security system is in an “armed” state, and a different schedule when the security system is in a “home” state. The routine repository and associated management system may allow for the lighting devices and the device manufacturer to design and access such routines even where the underlying data is not made available to them. As another example, a routine may specify behavior of a device such as a security light, path lighting, alarm systems, or the like based on the occupancy status of the home overall or upon occupancy status of a particular user or users, though the device may not have direct access to the occupancy status. In such a configuration, the home management system may execute the routine and use the data to instruct devices specified by the routine when to execute various functions without providing the underlying data. Continuing the examples above, the home management system may instruct the device(s) to specify behavior of the lighting devices and alarm systems based upon the occupancy data as defined in a routine, but without providing the occupancy data itself to the devices.

Similarly, in an embodiment routines may use information that has been derived, inferred, learned, or otherwise obtained indirectly by a home management system. For example, a home management system may learn user behavior such as home/away timing, sleeping/waking schedules, presence patterns, transitory events and event timing, meal timing, identity information, and the like. Such signals also may be available for use by routines and, as with the examples above, the underlying data or the signals themselves may not be available otherwise to providers or devices. As a specific example, a routine may specify that electronic devices in the home should be placed in a standby or shutdown state when presence information indicates that no occupants of the home are present and are not expected to be present for more than a minimum amount of time based on the occupants' typical, learned schedules. As another example, the home management system may have previously determined that there are often more non-occupants present in the home during a set period of time (e.g., 7-10 pm every Friday) and that a primary occupant of the home generally maintains a range of indoor temperatures (e.g., 70-72 degrees). When the system determines that it is during the period of time and non-occupants begin arriving, a routine may be used to adjust the thermostat based on the number and size/age of people in the home to maintain a relatively constant temperature.

In an embodiment, other data sources may be used by routines. For example, where a home management system has access to a user's email, calendar, schedule, or other personal information, it may be used in routines. As previously described, the underlying data—such as the actual email text, the calendar entries, or the schedule times and events—may not be provided to any given device or device provider, while still allowing routines to make use of the data.

In an embodiment, routines may be prioritized in the system relative to each other. For example, routines related to safety and security may be given priority over routines related to entertainment, daily routines, or the like if there is a conflict. For example, if one routine specifies “quiet hours” for some devices after a certain time, a security routine that alerts or alarms under conditions that may indicate an intruder may be given priority over the “quiet hours” routine. Prioritization may be set by a user, a routine repository, a home management system, a device and/or routine provider, or combinations thereof.

In an embodiment, a user may be notified of available routines when a device is first installed in a home, connected to a home network, or the like. For example, when a user first installs a networked television, the television or a separate user device such as a phone may display a notification of available routines in a routine repository. The user may then access a “discovery” or similar interface that shows the routines available for the television. The interface also may display routines available for other devices in the home, which may not have been available prior to installation of the new device. The user may select any routines of interest for more information, or to download, install, or otherwise activate the routine in the home. As previously disclosed, the home system or the routine repository may provide suggestions of additional features, devices, or routines that may interoperate with existing devices and/or routines in the home.

In an embodiment, routines may be generated and suggested by a home management system. For example, the system may learn that a user always activates certain devices at a particular time of day. The system may generate a basic routine that activates the most-commonly used devices during that time period and propose it as a new routine to the user. The user may be given an opportunity to accept, modify, or reject the routine.

In an embodiment, routines may operate to control device behavior based on external environmental factors or similar data, which may be used in conjunction with other routines and data sources. For example, a user may have an electric car that is normally charged nightly at the home. In the event of a brownout or blackout, a routine may specify that generator or battery power should be diverted from the charging station to other appliances such as a refrigerator, emergency lighting system, security system, or the like. The routine may take into account the level of charge in the car battery as well as the prioritization given to various devices and routines as previously disclosed.

In many cases, routines as disclosed herein operate using multiple types of devices in conjunction, in contrast to conventional “scheduling” functionality that may be available in individual devices. For example, although a conventional television may include a sleep timer, it does not have any mechanism to provide access for other devices, such as a security system, power management system, or the like to access and use the sleep timer to achieve a more robust effect such as enforcing quiet hours. Similarly, conventional “smart speakers” typically only allow for a user to define specific commands that the speaker will understand and use in order to send associated, preexisting commands, to other devices that are already connected to the speaker. Such devices do not have a mechanism to allow for integration of functionality of devices that originate from multiple sources, or for arbitrary combination of features and commands across such different devices.

In an embodiment, routines and/or additional devices or features may be suggested to a user based on factors other than whether the additional features may be of interest to the user. For example, alternative or additional devices may be suggested to the user based on expected operating cost, energy efficiency, device complexity or longevity, or similar factors, even where no additional features or comparable features would result. As a specific example, the system may suggest more energy efficient light bulbs or lighting devices and note the expected cost savings, energy use reduction, or other metrics for the user based on one or more routines in place at the home, regardless of whether the new devices would provide functionality different than devices currently in the home.

During operation of a system as disclosed herein, one or more routines may control operation of one or more devices in the home or other location. To do so, each device may be provided with a list of commands, behaviors, or other operating parameters using any suitable language, configuration protocol, or other interface which is capable of specifying operation of the device. Such commands may be provided by the device or the device provider, via the device, the routine repository, or any other suitable mechanism. For example, a compatible device may include an interface that it can provide upon request from another device in a home network, which specifies the commands, routines, behaviors, functions, and any other attributes of the device such as device type, capabilities, or the like. The home management system and/or the routine repository may match this information to existing routines based on the specification of those attributes, thereby allowing for similar devices with different interface protocols to be used interchangeably within routines that would apply to each device. For example, different security systems may have different names for the various modes in which they can operate, which may be specified using a common set of attributes such as whether all sensors/alarms are armed, timeout periods, sensitivity, and the like. The home management system and/or the routine repository may match these specified modes to equivalent modes in a generic home security routine, thereby allowing for the use of arbitrary security systems to achieve equivalent behavior in the home regardless of whether each system is provided by the same source or different sources. In many cases, such mapping of features to routines may be accomplished with little or no user intervention.

A routine repository as disclosed herein may be implemented locally to a home or other location, such as in part of a home management system. Such an embodiment may be desirable to achieve faster processing times and to maintain potentially personal information within the home network. Alternatively or in addition, some or all of the routine repository may be implemented as a cloud service. In an embodiment, a routine repository may be implemented as a cloud service that provides a general, comprehensive catalog of available routines, which then may be copied to a local routine repository or home management system for operation in the home. The local routine may be modified with information specific to the home or one or more users, such as to accommodate user- or location-specific data as previously disclosed. Similarly, a home management system may be implemented locally, remotely as a cloud-based service, or a combination thereof.

In an embodiment, a routine repository may include routines designed by end users, such as where end users are provided with a framework in which to define behaviors of their own devices, trigger events for such behaviors, links between device behaviors, and the like. The routines may be used locally at the user's home, and/or they may be provided by the user to a routine repository for use by other users. Such routines also may be used as a source of related routines, devices, and the like. For example, a first user may determine that an automated doorbell camera works especially well when a particular type of porch light is used, and the user may further define a schedule for the porch light based on data obtained from an outdoor light sensor. After creating this routine, the user may provide it to a routine store for use by other users. The routine could then be used to suggest the type of porch light to an owner of the same or similar doorbell camera, or vice versa. Similarly, the user's programmed schedule may be used as a recommendation for a routine for the light and/or the outdoor light sensor for other users.

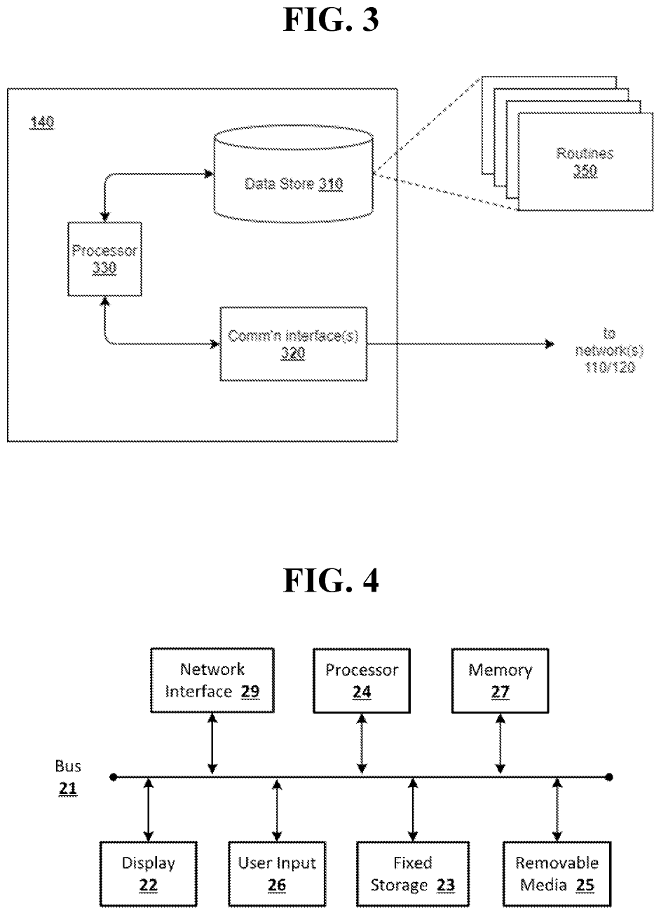

FIG. 3 shows a schematic example of a routine repository as disclosed herein. The repository 140 may be a computerized device that includes one or more processors 330. It may be implemented as a stand-alone device or system, such as one or more servers or a cloud service, or it may be integrated with other devices such as a home management system, cloud service provider, home management services provider system, or the like. It also may operate locally, such as where it is implemented in, or in conjunction with, a home management hub or similar device. The processor 330 may execute the operations described herein with respect to the routine repository, such as storing routines in the data store 310, managing communications with other devices, and the like. Such communications may be made via one or more communication interfaces 320, such as Wi-Fi, ethernet, Bluetooth and other near-field communications, and the like. The data store 310 may store one or more routines 350 as disclosed herein. The routines 350 may specify various functions and attributes of devices or device types, parameters regarding when those functions and attributes should and/or should not be used, and the like, as previously disclosed.

Embodiments disclosed herein may improve the operation, effectiveness, and efficiency of the devices operated by the routines as well as the home management system itself. For example, routines may be used to allocate resources to different devices based upon environmental conditions, thereby allowing for more efficient use of the resources and the devices. As a specific example, battery power may be more efficiently allocated among devices during a brownout or blackout, as previously disclosed. As another example, routines may specify when devices should operate in a common area or region without causing undue interference with one another, such as where one or more routines are used to stagger operation of automatic vacuum cleaners, security sensors, automatic environmental controls such as heating and air conditioning, and the like. By coordinating usage of various devices and different types of devices, the effective lifespan of the devices may be improved by reducing the times that each device operates at lower efficiency, for example due to concurrent operation of an interfering device. Embodiments disclosed herein also may improve the efficiency of user operation, since routines as disclosed herein allow users to connect new devices to a networked environment and have the devices operate efficiently with other devices, without the user needing to set individual schedules for each device or to determine what schedules have already been established before adding a new device to the system.

Embodiments disclosed herein may use one or more sensors. In general, a “sensor” may refer to any device that can obtain information about its environment. Sensors may be described by the type of information they collect. For example, sensor types as disclosed herein may include sensors to detect motion, smoke, carbon monoxide, proximity, temperature, time, physical orientation, acceleration, location, entry, presence, pressure, light, sound, and the like. A sensor also may be described in terms of the particular physical device that obtains the environmental information. For example, an accelerometer may obtain acceleration information, and thus may be used as a general motion sensor and/or an acceleration sensor. A sensor also may be described in terms of the specific hardware components used to implement the sensor. For example, a temperature sensor may include a thermistor, thermocouple, resistance temperature detector, integrated circuit temperature detector, or combinations thereof. A sensor also may be described in terms of a function or functions the sensor performs within an integrated sensor network, such as a home environment as disclosed herein. For example, a sensor may operate as a security sensor when it is used to determine security events such as unauthorized entry. A sensor may operate with different functions at different times, such as where a motion sensor is used to control lighting in a home environment when an authorized user is present and is used to alert to unauthorized or unexpected movement when no authorized user is present, or when an alarm system is in an “armed” state, or the like. In some cases, a sensor may operate as multiple sensor types sequentially or concurrently, such as where a temperature sensor is used to detect a change in temperature, as well as the presence of a person or animal. A sensor also may operate in different modes at the same or different times. For example, a sensor may be configured to operate in one mode during the day and another mode at night. As another example, a sensor may operate in different modes based upon a state of a home security system or a home environment, or as otherwise directed by such a system.

In general, a “sensor” as disclosed herein may include multiple sensors or sub-sensors, such as where a position sensor includes both a global positioning sensor (GPS) as well as a wireless network sensor, which provides data that can be correlated with known wireless networks to obtain location information. Multiple sensors may be arranged in a single physical housing, such as where a single device includes movement, temperature, magnetic, and/or other sensors. Such a housing also may be referred to as a sensor or a sensor device. For clarity, sensors are described with respect to the particular functions they perform and/or the particular physical hardware used, when such specification is necessary for understanding of the embodiments disclosed herein.

In some configurations, two or more sensors may generate data that can be used by a processor of a system to generate a response and/or infer a state of the environment. For example, an ambient light sensor may determine that it is dark (e.g., less than 60 lux) in the room of a home in which it is located. A microphone may detect a sound above a set threshold, such as 60 dB, in the home. The processor may determine, based on the data generated by both sensors that it should activate all of the lights in the room. In the event the processor only received data from the ambient light sensor, it may not have any basis to alter the state of the lighting in the room. Similarly, if the processor only received data from the microphone, it may not make sense to activate the lights in the room because it is daytime or bright in the room (e.g., the lights are already on). As another example, two or more sensors may communicate with one another. Thus, data generated by multiple sensors simultaneously or nearly simultaneously may be used to determine a state of an environment and, based on the determined state, generate a response.

Data generated by one or more sensors may indicate patterns in the behavior of one or more users and/or an environment state over time, and thus may be used to “learn” such characteristics. For example, data generated by an ambient light sensor in a room of a house and the time of day may be stored in a local or remote storage medium with the permission of an end user. A processor in communication with the storage medium may compute a behavior based on the data generated by the light sensor. The light sensor data may indicate that the amount of light detected increases until an approximate time or time period, such as 3:30 PM, and then declines until another approximate time or time period, such as 5:30 PM, at which point there is an abrupt increase in the amount of light detected. In many cases, the amount of light detected after the second time period may be either below a dark level of light (e.g., under or equal to 60 lux) or bright (e.g., equal to or above 400 lux). In this example, the data may indicate that after 5:30 PM, an occupant is turning on/off a light as the occupant of the room in which the sensor is located enters/leaves the room. At other times, the light sensor data may indicate that no lights are turned on/off in the room. The system, therefore, may learn the occupants' patterns of turning on and off lights, and may generate a response to the learned behavior. For example, at 5:30 PM, a home environment or other sensor network may automatically activate the lights in the room if it detects an occupant in proximity to the home. In some embodiments, such behavior patterns may be verified using other sensors. Continuing the example, user behavior regarding specific lights may be verified and/or further refined based upon states of, or data gathered by switches, outlets, lamps, and the like.

Sensors as disclosed herein may operate within a communication network, such as a conventional wireless network, and/or a sensor-specific network through which sensors may communicate with one another and/or with dedicated other devices. In some configurations one or more sensors may provide information to one or more other sensors, to a central controller, or to any other device capable of communicating on a network with the one or more sensors. A central controller may be general- or special-purpose. For example, one type of central controller is a home automation network, that collects and analyzes data from one or more sensors within the home. Another example of a central controller is a special-purpose controller that is dedicated to a subset of functions, such as a security controller that collects and analyzes sensor data primarily or exclusively as it relates to various security considerations for a location. A central controller may be located locally with respect to the sensors with which it communicates and from which it obtains sensor data, such as in the case where it is positioned within a home that includes a home automation and/or sensor network. Alternatively, or in addition, a central controller as disclosed herein may be remote from the sensors, such as where the central controller is implemented as a cloud-based system that communicates with multiple sensors, which may be located at multiple locations and may be local or remote with respect to one another.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, specific information about a user's residence may be treated so that no personally identifiable information can be determined for the user, or a user's geographic location may be generalized where location information is obtained (such as to a city, ZIP code, or state level), so that a particular location of a user cannot be determined. As another example, systems disclosed herein may allow a user to restrict the information collected by those systems to applications specific to the user, such as by disabling or limiting the extent to which such information is aggregated or used in analysis with other information from other users. Thus, the user may have control over how information is collected about the user and used by a system as disclosed herein.

Various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as hard drives, USB (universal serial bus) drives, or any other machine readable storage medium, such that when the computer program code is loaded into and executed by a computer, the computer becomes an apparatus for practicing embodiments of the disclosed subject matter. When implemented on a general-purpose microprocessor, the computer program code may configure the microprocessor to become a special-purpose device, such as by creation of specific logic circuits as specified by the instructions.

Embodiments of the presently disclosed subject matter may be implemented in and used with a variety of computing devices. FIG. 4 shows a schematic representation of a device 20 suitable for implementing embodiments of the presently disclosed subject matter. For example, the device 20 may be used to implement a device 101, 102, 103, 101n; a routine repository 140, a server or cloud service 130, or the like. Alternatively, or in addition, the device 20 may be, for example, a desktop or laptop computer, or a mobile computing device such as a phone, tablet, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components 25, 27, which may include RAM, ROM, and other memory, as previously noted. Applications resident with the computer 20 are generally stored on and accessed via a computer readable storage medium.

The fixed storage 23 may be integral with the computer 20 or may be separate and accessed through other interfaces. The network interface 29 may provide a direct connection to a remote server via a wired or wireless connection, for example to implement the communication interface(s) 320 in FIG. 3 and other similar interfaces for the various devices disclosed herein. The network interface 29 may provide such connection using any suitable technique and protocol as will be readily understood by one of skill in the art, including digital cellular telephone, Wi-Fi, Bluetooth®, near-field, and the like. For example, the network interface 29 may allow the device to communicate with other computers via one or more local, wide-area, or other communication networks, as described in further detail herein.

Embodiments may be implemented using hardware that may include a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

What is claimed is:

1. A computer-implemented method comprising:
detecting, by a home management system, that a first device is connected to a communication network of the home management system;
obtaining model information about the device, the model information comprising at least a first feature of the first device available for use;
obtaining a first predefined routine defining a plurality of functions and specifying one or more parameters under which one or more of the plurality of functions is used by the routine, at least a first function of the plurality of functions making use of the first feature of the first device;
presenting the first routine to a user of the home management system; and
responsive to receiving approval of the first routine from the user, implementing the first predefined routine by the home management system to cause the first device to use the first feature based upon the parameters.

2. The method of claim 1, wherein the first predefined routine is obtained from the first device, a routine repository storing a plurality of predefined routines, or from a provider of the first device.

3. The method of claim 2, wherein the first predefined routine is obtained from the routine repository storing a plurality of predefined routines, and wherein the plurality of predefined routines includes routines suitable for use with devices from a plurality of independent and distinct sources.

4. The method of claim 2, wherein the first predefined routine is obtained from the first device and specifies a second device that is capable of performing one or more other functions defined in the first predefined routine that are not performed by the first device.

5. The method of claim 1, further comprising:
identifying, by the home management system, a second device already installed in the home that is capable of executing at least a second function of the plurality of functions;
presenting an identification of the second device to the user; and
responsive to receiving approval of the first routine from the user, implementing the first predefined routine by the home management system to cause the second device to execute the second function as defined in the first routine.

6. The method of claim 1, further comprising:
identifying, by the home management system, a second device that is not already installed in the home that is capable of executing at least a second function of the plurality of functions;
identifying the second device to the user and providing an interface for the user to obtain the second device; and
responsive to an instruction received from the user, purchasing the second device.

7. The method of claim 1, wherein the parameters specify environmental conditions under which the first function is performed.

8. The method of claim 1, wherein the parameters specify a behavior of the first device based on a presence or absence of another device connected to the communication network.

9. The method of claim 1, wherein the first routine comprises a schedule of operation of the first device which specifies one or more times that the first function will be performed, one or more times that the first function will not be performed, or a combination thereof.

10. The method of claim 1, wherein the parameters are based on information available from the home management system that is not otherwise available to the first device.

11. The method of claim 1, wherein the first routine is generated automatically by the home management system based at least in part upon a behavior of an occupant of the home previously determined by the home management system.

12. A system comprising:
a home management system hub configured to:
detect when a first electronic device is connected to a communication network of the home management system;
obtain model information about the device, the model information comprising at least a first feature of the first device available for use;
obtain a first predefined routine defining a plurality of functions and specifying one or more parameters under which one or more of the plurality of functions is used by the routine, at least a first function of the plurality of functions making use of the first feature of the first device;
present the first routine to a user of the home management system; and
responsive to receiving approval of the first routine from the user, implementing the first predefined routine by the home management system to cause the first device to use the first feature based upon the parameters.

13. The system of claim 12, further comprising the first electronic device.

14. The system of claim 12, further comprising a routine repository storing a plurality of predefined routines including the first predefined routine.

15. The system of claim 12, wherein the first predefined routine is obtained from the first electronic device, a routine repository storing a plurality of predefined routines, or from a provider of the first device.

16. The system of claim 12, wherein the home management system hub is further configured to:
identify, a second device already installed in the home that is capable of executing at least a second function of the plurality of functions;
present an identification of the second device to the user; and
responsive to receiving approval of the first routine from the user, implement the first predefined routine by the home management system to cause the second device to execute the second function as defined in the first routine.

17. The system of claim 12, wherein the home management system hub is further configured to:
identify a second device that is not already installed in the home that is capable of executing at least a second function of the plurality of functions;
identify the second device to the user and providing an interface for the user to obtain the second device; and
responsive to an instruction received from the user, purchase the second device.

18. The system of claim 12, wherein the parameters specify environmental conditions under which the first function is performed.

19. The system of claim 12, wherein the parameters specify a behavior of the first device based on a presence or absence of another device connected to the communication network.

20. The system of claim 12, wherein the first routine comprises a schedule of operation of the first device which specifies one or more times that the first function will be performed, one or more times that the first function will not be performed, or a combination thereof.

21. The system of claim 12, wherein the parameters are based on information available from the home management system that is not otherwise available to the first device.

22. The system of claim 12, wherein the first routine is generated automatically by the home management system based at least in part upon a behavior of an occupant of the home previously determined by the home management system.

23. A device comprising:
a processor;
a communication interface communicatively coupled to the processor; and
a data store communicatively coupled to the processor, the data store storing a plurality of routines usable by a plurality of devices, each routine specifying one or more parameters under which one or more device functions is used in the routine within a home management system wherein, when executed by the home management system, an executed routine causes one or more devices to operate according to the parameters.

24. The device of claim 23, wherein the device further comprises a home management system hub.

25. The device of claim 23, wherein the device is a component of a cloud service provider.

26. A non-transitory computer-readable medium storing a plurality of instructions which, when executed by a computer processor, cause the processor to:
detect that a first device is connected to a communication network of the home management system;
obtain model information about the device, the model information comprising at least a first feature of the first device available for use;
obtain a first predefined routine defining a plurality of functions and specifying one or more parameters under which one or more of the plurality of functions is used by the routine, at least a first function of the plurality of functions making use of the first feature of the first device;
present the first routine to a user of the home management system; and
responsive to receiving approval of the first routine from the user, implement the first predefined routine by the home management system to cause the first device to use the first feature based upon the parameters.
